(19) United States
(12) Patent Application Publication
(10) Pub. No.: US 2026/0270371 A1
(43) Pub. Date: Sep. 10, 2026

(54) HYBRID SENSOR FUSION FOR AVATAR GENERATION

(71) Applicant: Hewlett-Packard Development Company, L.P., Spring, TX (US)

(72) Inventors: Yin-Lun Huang, Taipei City (TW); Yi-Kang Hseih, Taipei City (TW); Wei-Ting Sun, Taipei City (TW); Hung-Chi Shih, Taipei City (TW)

(21) Appl. No.: 19/167,185

(22) PCT Filed: Apr. 18, 2023
(86) PCT No.: PCT/US2023/019001

§ 371 Date: Sep. 19, 2025

(51) Int. Cl. H04N 7/15; G06V 10/26; G06V 40/16

(52) U.S. Cl. CPC H04N 7/157; G06V 10/26; G06V 40/171

(57) ABSTRACT

Systems and methods are provided for implementing hybrid sensor fusion for avatar generation. One method can include receiving, via a first camera (225) of a wearable device (205), a first image data stream that can include a facial feature of a participant. The method can also include receiving, via a second camera (255) separate from the wearable device, a second image data stream that can include a non-facial feature of the participant. The method can also include generating an avatar of the participant, where a first portion of the avatar including the facial feature can be generated based on the first image data stream and a second portion of the avatar including the non-facial feature can be generated based on the second image data stream.

### BACKGROUND

Video conferencing technology enables users to communicate with one another from remote locations. For example, each participant in a video conference may include a computing device (e.g., a desktop computer, laptop, tablet, etc.) with a webcam that generates an audio and video stream that conveys the participant's voice and appearance, with a speaker that outputs audio received from audio streams of other participants, and with a display that outputs video from video streams of other participants. In some examples, video conference technology enables participants to participate in a video conference via an avatar, rather than a video stream of the participant. In this context, an avatar is a graphical representation (or electronic image) of a user, such as an icon or figure. Accordingly, in such an example, rather than a first participant seeing a video stream of a second participant, the first participant sees an avatar of the second participant on the display.

The discussion above is merely provided for general background information and is not intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 schematically illustrates a system for implementing communication between one or more user systems according to some examples.

FIG. 2 schematically illustrates a system of implementing hybrid sensor fusion for avatar generation according to some examples.

FIG. 3 is a flowchart illustrating a method for implementing hybrid sensor fusion for avatar generation according to some examples.

FIG. 4 is a flowchart illustrating an example avatar generation process according to some examples.

FIG. 5 illustrates a set of facial segments according to some examples.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

As described above, video conferencing technology enables users to communicate with one another from remote locations. For example, each participant in a video conference may include a computing device (e.g., a desktop computer, laptop, tablet, etc.) with a webcam that generates an audio and video stream that conveys the participant's voice and appearance, with a speaker that outputs audio received from audio streams of other participants, and with a display that outputs video from video streams of other participants. In some examples, video conference technology enables participants to participate in a video conference via an avatar, rather than a video stream of the participant. In this context, an avatar is a graphical representation (or electronic image) of a user, such as an icon or figure. Accordingly, in such an example, rather than a first participant seeing a video stream of a second participant, the first participant sees an avatar of the second participant on the display.

In a hybrid work environment, where users can join a video conference either physically or virtually, having avatars to represent the participants can greatly improve the video conferencing experience for the participants. Additionally, tracking cameras can be used in photorealistic avatar generation, where physical movements of the participant in the real or physical world can be detected by the tracking cameras and can then be reflected in movements by the avatar. However, no industry standards or specifications exists for tracking cameras used in photorealistic avatar generation. Additionally, such a process can involve specific tracking cameras, which can significantly increase overall cost, algorithm complexity, and power consumption of the system.

Accordingly, in some examples, the technology disclosed herein can provide a hybrid sensor fusion system for avatar creation with enhanced facial expression. The system can include capturing image data of a participant from two or more cameras, where at least one camera can be positioned within a wearable device, such as a head-mounted display (HMD), and at least one additional camera can be positioned external to the wearable device (e.g., a PC webcam). The image data can be fed into appropriate tracking algorithms (e.g., eye gaze tracking, head pose tracking, lip movement tracking, body parts tracking, etc.). The output of each tracking algorithm can be fed into one or more avatar creation engines (e.g., an avatar real-time texture engine, an avatar machine learning engine, an avatar real-time modeling engine, etc.). The avatar creation engines can generate the avatar of the participant for display to another participant. Accordingly, even when facial features are blocked by the wearable device from the vantage point of an additional camera (e.g., the PC webcam), the avatar creation engine(s) can still take facial features from the camera positioned within the wearable device and generate an avatar with rich facial expression.

In some examples, the technology disclosed herein provides a system. The system can include a first camera to detect a first image data stream including a facial feature of a participant, the first camera included in a wearable device worn by the participant. The system can include a second camera to detect a second image data stream including a non-facial feature of the participant, the second camera separate from the wearable device. The system can include an electronic processor to receive, from the first camera, the first image data stream; receive, via the second camera, the second image data stream; and generate an avatar of the participant, wherein a first portion of the avatar including the facial feature is generated based on the first image data stream and a second portion of the avatar including the non-facial feature is generated based on the second image data stream.

In some examples, the technology disclosed herein provides a method. The method can include receiving, via a first camera of a wearable device, a first image data stream that includes a facial feature of a participant. The method can include receiving, via a second camera separate from the wearable device, a second image data stream that includes a non-facial feature of the participant. The method can include generating an avatar of the participant, wherein a first portion of the avatar including the facial feature is generated based on the first image data stream and a second portion of the avatar including the non-facial feature is generated based on the second image data stream.

In some examples, the technology disclosed herein provides a non-transitory computer-readable medium storing instructions that, when executed by an electronic processor, perform a set of functions. The set of functions can include receiving, via a first camera of a wearable device, a first image data stream that includes a facial feature of a participant. The set of functions can include receiving, via a second camera separate from the wearable device, a second image data stream that includes a non-facial feature of the participant. The set of functions can include generating an avatar of the participant, wherein a first portion of the avatar including the facial feature is generated based on the first image data stream and a second portion of the avatar including the non-facial feature is generated based on the second image data stream.

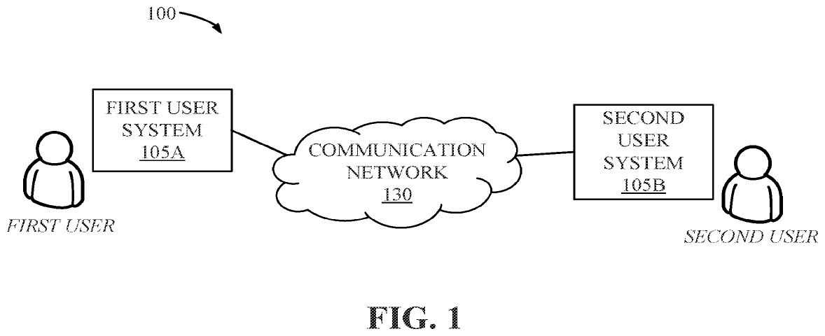

FIG. 1 illustrates a system 100 for implementing communication between one or more user systems, according to some examples. For example, the system 100 can enable a video conference between one or more users as participants in the video conference. In the example illustrated in FIG. 1, the system 100 includes a first user system 105A and a second user system 105B (collectively referred to herein as “the user systems 105″ and generically referred to as ”the user system 105″). The system 100 can include additional, fewer, or different user systems than illustrated in FIG. 1 in various configurations. Each user system 105 can be associated with a user. For example, the first user system 105A can be associated with a first user and the second user system 105B can be associated with a second user.

The first user system 105A and the second user system 105B can communicate over one or more wired or wireless communication networks 130. Portions of the communication networks 130 can be implemented using a wide area network, such as the Internet, a local area network, such as a Bluetooth™ network or Wi-Fi, and combinations or derivatives thereof. Alternatively, or in addition, in some examples, two or more components of the system 100 can communicate directly as compared to through the communication network 130. Alternatively, or in addition, in some examples, two or more components of the system 100 can communicate through one or more intermediary devices not illustrated in FIG. 1.

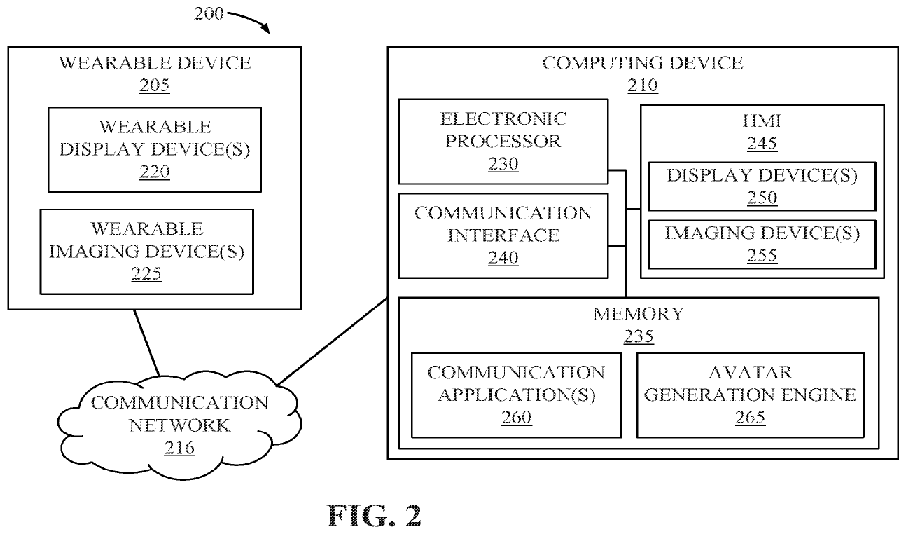

FIG. 2 illustrates a system 200 for implementing hybrid sensor fusion for avatar generation or creation, according to some examples. The system 200 of FIG. 2 can be an example of the user system(s) 105 of FIG. 1. As illustrated in the example of FIG. 2, the system 200 can include a wearable device 205 and a computing device 210. In some examples, the system 200 can include fewer, additional, or different components in different configurations than illustrated in FIG. 2. For example, as illustrated, the system 200 includes one wearable device 205 and one computing device 210. However, in some examples, the system 200 can include fewer or additional wearable devices 205, computing devices 210, or a combination thereof. As another example, one or more components of the system 200 can be combined into a single device, divided among multiple devices, or a combination thereof.

The wearable device 205 and the computing device 210 can communicate over one or more wired or wireless communication networks 216. Portions of the communication networks 216 can be implemented using a wide area network, such as the Internet, a local area network, such as a Bluetooth™ network or Wi-Fi, and combinations or derivatives thereof. The communication network 216 can include or be the communication network 130 of FIG. 1. Alternatively, the communication network 216 can be a different communication network than the communication network 130 of FIG. 1. In some examples, the communication network 216 represents a direct wireless link between two components of the system 200 (e.g., via a Bluetooth™ or Wi-Fi link). Alternatively, or in addition, in some examples, two or more components of the system 200 can communicate through one or more intermediary devices of the communication network 216 not illustrated in FIG. 2.

In the illustrated example of FIG. 2, the wearable device 205 can include wearable display device(s) 220 (collectively referred to herein as “the wearable display devices 220” and individually as “the wearable display device 220”) and wearable imaging devices 225 (collectively referred to herein as “the wearable imaging devices 225” and individually as “the wearable imaging device 225”). Although not illustrated in FIG. 2, the wearable device 205 can include similar components as the computing device 210, such as an electronic processor (for example, a microprocessor, an application-specific integrated circuit (ASIC), or another suitable electronic device), a memory (for example, a non-transitory, computer-readable storage medium), a communication interface, such as a transceiver, for communicating over the communication network 216 (or the communication network 130 of FIG. 1) and, optionally, one or more additional communication networks or connections, and one or more human machine interfaces (as described in greater detail herein with respect to the computing device 210).

The wearable device 205 can be an accessory to be worn by a user so as to present virtual images and, in some examples, audio to the user wearing the wearable device 205. For example, the wearable device 205 can be headwear, such as, e.g., a head-mounted display (“HMD”). In some examples, the wearable device 205 can be in the form of a headset or glasses resting above a nose and in front of the eyes of the user. The wearable display device 220, the wearable imaging device 225, or a combination thereof can be a component of the wearable device 205. For example, the wearable display device 220, the wearable imaging device 225, or a combination thereof can be included in the wearable device 205 (e.g., included internally, physically or structurally mounted, etc. to the wearable device 205).

The wearable display device 220 can display (or otherwise output) visual data to a wearer of the wearable device 205. For example, when the wearable device 205 is a HMD, the wearable display device 220 can optically overlay or project a computer-generated image (e.g., a virtual image with virtual objects) on top of the user's view through a lens portion of the wearable device 205. In other examples, when the wearable device 205 is an HMD, the wearable display device 220 includes an opaque display (e.g., without a lens through which the user can see outside of the HMD).

The wearable imaging device 225 can electronically capture or detect a visual image (as an image data signal or data stream). A visual image can include, e.g., a still image, a moving-image, a video stream, other data associated with providing a visual output, and the like. The wearable imaging device 225 can include one or more cameras, such as, e.g., a webcam, an image sensor, or the like. For example, the wearable imaging device 225 can detect image data associated with a user of the wearable device 205. For instance, when a user wears the wearable device 205, the wearable device 205 can obstruct at least a portion of the user from an external viewpoint (e.g., from an external user's perspective). A portion of the user obstructed by the wearable device 205 can be referred to herein as an obstructed feature or portion. For example, when the wearable device 205 is an HMD, the wearable device 205 can obstruct at least one facial feature of the user. A facial feature can include, e.g., an eye, an eyebrow, a forehead, a nose, a cheek, a mouth, a chin, etc. Accordingly, in some examples, the wearable imaging device 225 captures inward-facing data associated with the user, including, e.g., obstructed feature(s) of the user.

Alternatively, or in addition, in some examples, the wearable device 205 can include additional components or devices for detecting data associated with the user (e.g., an obstructed feature of the user, a behavior or characteristic indicative of a body language or attitude of the user, etc.). For example, the wearable device 205 can include one or more sensors, such as, e.g., an inertial motion unit (“IMU”), a temperature sensor, a biometric sensor, etc.

The computing device 210 can include, e.g., a desktop computer, a laptop computer, a tablet computer, an all-in-one computer, a notebook computer, a terminal, a smart telephone, a smart television, or another suitable computing device that interfaces with a user. As described in greater detail herein, the computing device 210 can be used by a user for interacting with a communication platform (e.g., participating in a video conference hosted by a communication platform), including, e.g., generating an avatar representing a user within the communication platform.

A communication platform can be a computing platform (such as, e.g., a hardware and software architecture) that enables communication functionality. A “platform” is generally understood to refer to hardware or software used to host an application or service. In the context of the technology disclosed herein, a “communication platform” can refer to hardware or software used to host a communication application or communication service (e.g., a hardware and software architecture that functions as a foundation upon which communication applications, services, processes, or the like are implemented).

The communication platform can enable a communication session. A communication session can be a session enabling interactive expression and information exchange between one or more communication devices, such as, e.g., the computing device 210 (or the users associated therewith). A communication session can be a multimedia communication session, an audio communication session, a video communication session, or the like. A communication session can be a web communication session, such as, e.g., a server-side web session, a client-side web session, or the like. Alternatively, or in addition, the communication platform can implement one or more communication or transmission protocols, session management techniques, or the like as part of enabling a communication session.

A user interaction with a communication platform can include, e.g., hosting a communication session, participating in a communication session, preparing for a future communication session, viewing a previous communication session, and the like. A communication session can include, for example, a video conference, a group call, a webinar (e.g., a live webinar, a pre-recorded webinar, and the like), a collaboration session, a workspace, an instant messaging group, or the like. Accordingly, in some examples, to access and interact with a communication platform (hosted by a remote server or cloud service), the computing device 210 can store a browser application or a dedicated software application (as described in greater detail herein).

As illustrated in FIG. 2, the computing device 210 includes an electronic processor 230, a memory 235, a communication interface 240, and a human-machine interface (“HMI”) 245. The electronic processor 230, the memory 235, the communication interface 240, and the HMI 245 can communicate wirelessly, over one or more communication lines or buses, or a combination thereof. The computing device 210 can include additional, different, or fewer components than those illustrated in FIG. 2 in various configurations. The computing device 210 can perform additional functionality other than the functionality described herein. Also, the functionality (or a portion thereof) described herein as being performed by the computing device 210 can be performed by another component (e.g., the wearable device 205, a remote server or computing device, another computing device, or a combination thereof), distributed among multiple computing devices (e.g., as part of a cloud service or cloud-computing environment), combined with another component (e.g., the wearable device 205, a remote server or computing device, another computing device, or a combination thereof), or a combination thereof.

The communication interface 240 can include a transceiver that communicates with the wearable device 205, another device of the system 200, another device external or remote to the system 200, or a combination thereof over the communication network 216 and, optionally, one or more other communication networks or connections (e.g., the communication network 130 of FIG. 1, such as when communicating with another user system 105). The electronic processor 230 includes a microprocessor, an ASIC, or another suitable electronic device for processing data, and the memory 235 includes a non-transitory, computer-readable storage medium. The electronic processor 230 is configured to retrieve instructions and data from the memory 235 and execute the instructions.

As illustrated in FIG. 2, the computing device 210 can also include the HMI 245 for interacting with a user. The HMI 245 can include one or more input devices, one or more output devices, or a combination thereof. Accordingly, in some examples, the HMI 245 allows a user to interact with (e.g., provide input to and receive output from) the computing device 210. For example, the HMI 245 can include a keyboard, a cursor-control device (e.g., a mouse), a touch screen, a scroll ball, a mechanical button, a display device (e.g., a liquid crystal display (“LCD”)), a printer, a speaker, a microphone, or a combination thereof.

In the illustrated example of FIG. 2, the HMI 245 includes at least one display device 250 (referred to herein collectively as “the display devices 250” and individually as “the display device 250”). The display device 250 can be included in the same housing as the computing device 210 or can communicate with the computing device 210 over one or more wired or wireless connections. As one example, the display device 250 can be a touchscreen included in a laptop computer, a tablet computer, or a smart telephone. As another example, the display device 250 can be a monitor, a television, or a projector coupled to a terminal, desktop computer, or the like via one or more cables.

The display device 250 can provide (or output) one or more media signals to a user. As one example, the display device 250 can display a user interface (e.g., a graphical user interface (GUI)) associated with a communication platform (including, e.g., a communication session thereof), such as, e.g., a communication session user interface. In some examples, the user interface can include a set of avatars representing participants of a communication session, which can additionally or alternatively be shown on the wearable display device 220.

The HMI 245 can also include at least one imaging device 255 (referred to herein collectively as “the imaging devices 255” and individually as “the imaging device 255”). The imaging device 255 can be a component associated with the computing device 210 (e.g., included in the computing device 210 or otherwise communicatively coupled with the computing device 210). In some examples, the imaging device 255 can be internal to the computing device 210 (e.g., a built-in webcam). Alternatively, or in addition, the imaging device 255 can be external to the computing device 210 (e.g., an external webcam positioned on a monitor of the computing device 210, on a desk, shelf, wall, ceiling, etc.). As illustrated in FIG. 2, the imaging device 255 of the computing device 210 can be separate from the wearable device 205. For instance, the imaging device 255 of the computing device 210 is external to, independent of, discrete from, unattached to, etc. with respect to the wearable device 205. In some examples, the imaging device 255 of the computing device 210 is not worn by a user (e.g., is not structurally coupled or mounted to the wearable device 205).

The imaging device 255 can electronically capture or detect a visual image (as an image data signal or data stream). A visual image can include, e.g., a still image, a moving-image, a video stream, other data associated with providing a visual output, and the like. The imaging device 255 can include one or more cameras, such as, e.g., a webcam, an image sensor, or the like. For example, the imaging device 255 can detect image data associated with a physical surrounding or environment of the computing device 210. As noted above, when a user wears the wearable device 205, the wearable device 205 can obstruct at least a portion of the user from an external viewpoint (e.g., from a perspective of the imaging device 255 of the computing device 210). Accordingly, in some examples, the imaging device 255 can detect image data associated with a user wearing the wearable device 205, including, e.g., the wearable device 205 itself (as an obstruction). Accordingly, in some examples, the imaging device 255 captures outward-facing data associated with the physical surrounding or environment of the computing device 210, including, e.g., the user, the wearable device 205 (as an obstruction to the user), etc.

As illustrated in FIG. 2, the memory 235 can include at least one communication application 260 (referred herein collectively as “the communication applications 260” and individually as “the communication application 260”). The communication application 260 is a software application executable by the electronic processor 230 in the example illustrated and as specifically discussed below, although a similarly purposed module can be implemented in other ways in other examples.

The communication application 260 can be associated with at least one communication platform (e.g., an electronic communication platform). As one example, a user can access and interact with a corresponding communication platform via the communication application 260. In some examples, the memory 235 includes multiple communication applications 260. In such examples, each communication application 260 is associated with a different communication platform. As one example, the memory 235 can include a first communication application associated with a first communication platform, a second communication application associated with a second communication platform, and an nth communication application associated with an nth communication platform.

The electronic processor 230 can execute the communication application 260 to enable user interaction with a communication platform (e.g., a communication platform associated with the communication application 260), including, e.g., generation or creation of an avatar representing the user for use within the communication platform. The communication application 260 can be a web-browser application that enables access and interaction with a communication platform, such as, e.g., a communication platform hosted by a remote server (e.g., where the communication platform is a web-based service). Alternatively, or in addition, the communication application 260 can be a dedicated software application that enables access and interaction with a communication platform. Accordingly, in some examples, the communication application 260 can function as a software application that enables access to a communication platform or service. Alternatively, or in addition, in some examples, the memory 235 can include additional or different applications that leverage avatars, including, e.g., a gaming application, a virtual reality or world application, etc.

As illustrated in FIG. 2, the memory 235 can also include an avatar generation engine 265. The avatar generation engine 265 is a software application executable by the electronic processor 230 in the example illustrated and as specifically discussed below, although a similarly purposed module can be implemented in other ways in other examples.

The electronic processor 230 can execute the avatar generation engine 265 to generate an avatar representing a user. In some examples, the electronic processor 230 can execute the avatar generation engine 265 to perform a hybrid sensor fusion and generate the avatar based on the hybrid sensor fusion, as described in greater detail herein. For instance, the avatar generation engine 265 (when executed by the electronic processor 230) can receive multiple image data streams from one or more sources (e.g., the wearable imaging device 225 of the wearable device 205 and the imaging device 255 of the computing device 210). The avatar generation engine 265 (when executed by the electronic processor 230) can perform hybrid sensor fusion techniques or functionality with respect to the image data streams and generate an avatar based on the hybrid sensor fusion, as described in greater detail herein. In some examples, the avatar can be leveraged by one or more applications, e.g., the communication application 260. For example, the communication application 260 can access the avatar and use (or publish) the avatar within a communication session as a representation of the user such that the avatar is viewable by other participants in the communication session.

In some examples, the avatar generation engine 265 can include an avatar real-time texture engine, an avatar machine learning engine, an avatar real-time modeling engine, and the like. An avatar real-time texture engine can perform texture related functionality, including, e.g., applying a three-dimensional (3D) texture (e.g., a bitmap image containing information in three dimensions) to an object or model. An avatar machine learning engine can perform, e.g., interactive avatar development and deployment related functionality using one or more pre-trained interactive animation algorithms (e.g., a pre-trained deep neural network). An avatar real-time modeling engine can perform real-time 3D creation functionality, such as, e.g., for photoreal visuals and immersive experiences, as part of a 3D development process.

The memory 235 can include additional, different, or fewer components in different configurations. Alternatively, or in addition, in some examples, one or more components of the memory 235 can be combined into a single component, distributed among multiple components, or the like. As one example, in some examples, the avatar generation engine 265 can be included as part of the communication application 260. Alternatively, or in addition, in some examples, one or more components of the memory 235 can be stored remotely from the computing device 210, such as, e.g., in a remote database, a remote server, another computing device, an external storage device, or the like.

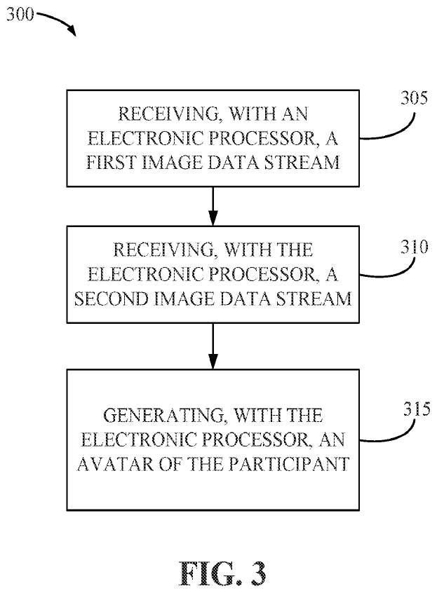

FIG. 3 is a flowchart illustrating a method 300 for implementing hybrid sensor fusion for avatar generation or creation, according to some examples. The method 300 is described as being performed by the computing device 210 and, in particular, the electronic processor 230 executing the communication application 260, the avatar generation engine 265, or a combination thereof. However, as noted above, the functionality described with respect to the method 300 can be performed by other devices, such as the wearable device 205, a remote server or computing device, another component of the system 200, or a combination thereof, or distributed among a plurality of devices, such as a plurality of servers included in a cloud service (e.g., a web-based service executing software or applications associated with a communication platform or application).

As illustrated in FIG. 3, the method 300 includes receiving, with the electronic processor 230, a first image data stream (at block 305). In some examples, the electronic processor 230 receives the first image data stream from the wearable imaging device 225 of the wearable device 205 (e.g., a first camera). The electronic processor 230 can receive the first image data stream over the communication network 216 via the communication interface 240 of the computing device 210. As noted above, the wearable imaging device 225 can detect or capture inward-facing data associated with the user, including, e.g., obstructed feature(s) of the user. For example, the wearable imaging device 225 can cover or obstruct from (external) view a facial feature of the user wearing the wearable imaging device 225, referred to as an obstructed facial feature. An obstructed facial feature may include, e.g., the eyes, eyebrows, upper cheek, or forehead of the user. Accordingly, in some examples, the first image data stream received at block 305 can include a facial feature of a participant (e.g., of a user wearing the wearable device 205).

The electronic processor 230 can receive a second image data stream (at block 310). In some examples, the electronic processor 230 receives the second image data stream from an imaging device (e.g., a second camera) separate from the wearable device 205, such as, e.g., the imaging device 255 of the computing device 210. As noted above, the imaging device 255 of the computing device 210 can detect or capture outward-facing data associated with the physical surrounding or environment of the computing device 210, including, e.g., the user wearing the wearable device 205, the wearable device 205 (as an obstruction to at least one facial feature of the user), etc. Accordingly, in some examples, the second image data stream received at block 310 can include a non-facial feature of the participant (e.g., a user wearing the wearable device 205).

The electronic processor 230 can generate an avatar of the participant (at block 315). The electronic processor 230 can generate the avatar based on the first image data stream, the second image data stream, or a combination thereof. In some examples, a portion of the avatar that includes a facial feature can be generated based on the first image data stream and a portion of the avatar that includes a non-facial feature can be generated based on the second image data stream.

In some examples, the electronic processor 230 can provide the image data streams (or segmentations thereof) to appropriate tracking algorithms (e.g., an eye gaze tracking algorithm, a head pose tracking algorithm, a lip movement tracking algorithm, a body parts tracking algorithm, etc.). For instance, the electronic processor 230 can segment or partition the image data streams into segmented datasets based on facial features (or facial segments). As one example, the electronic processor 230 can generate a segmented dataset that includes visual image data for an eyes segment or portion. The electronic processor 230 can generate a segmented dataset associated with an eyes segment for the first image data stream, the second image data stream, or a combination thereof. For example, the electronic processor 230 can generate a first segmented dataset associated with an eyes segment for the first image data stream and a second segmented dataset associated with an eyes segment for the second image data stream.

In some examples, the electronic processor 230 can perform a facial image segmentation on image data streams (e.g., the first image data stream, the second image data stream, or a combination thereof). The electronic processor 230 can perform the facial image segmentation by generating segmented datasets (e.g., a first set of segmented datasets from the first image data stream, a second set of segmented datasets from the second image data stream, etc.). The electronic processor 230 can identify a segmented dataset from the set of segmented datasets, where the segmented dataset can be specific to a facial segment or feature. For example, the electronic processor 230 can identify segmented datasets associated with an eyes segment from a set of segmented datasets associated with a particular image data stream. In some examples, the electronic processor 230 can identify multiple segmented datasets from different sets of segmented datasets, where the multiple segmented datasets are each associated with the same facial segment or feature. For example, the electronic processor 230 can identify a first segmented dataset from the first set of segmented datasets and a second segmented dataset from the second segmented datasets, where the first segmented dataset and the second segmented dataset each include visual data associated with the same facial segment.

The electronic processor 230 can provide the segmented datasets to appropriate tracking algorithms based on facial segment or feature. For instance, the electronic processor 230 can provide segmented dataset(s) associated with a specific facial segment to a tracking algorithm specific to the facial segment. As one example, the electronic processor 230 can provide segmented datasets associated with an eyes segment to an eye tracking algorithm and segmented datasets associated with a mouth segment to a mouth tracking algorithm. Accordingly, in some examples, the electronic processor 230 can access a tracking algorithm and apply the tracking algorithm to visual image data (or segmentations thereof).

The output of each tracking algorithm can be fed into the avatar generation engine 265, which can include, e.g., an avatar real-time texture engine, an avatar machine learning engine, an avatar real-time modeling engine, etc. The avatar generation engine 265 (when executed by the electronic processor 230) can generate the avatar of the participant for display to, e.g., the participant, another participant, etc. In some examples, the electronic processor 230 can display the avatar of the participant via the display device 250 of the computing device 210. Alternatively, or in addition, the electronic processor 230 can transmit the avatar (over the communication network 130, 216) to a remote computing device (e.g., a computing device included in another user or participant's system) such that the avatar can be displayed via a display device of the remote computing device to at least one additional participant.

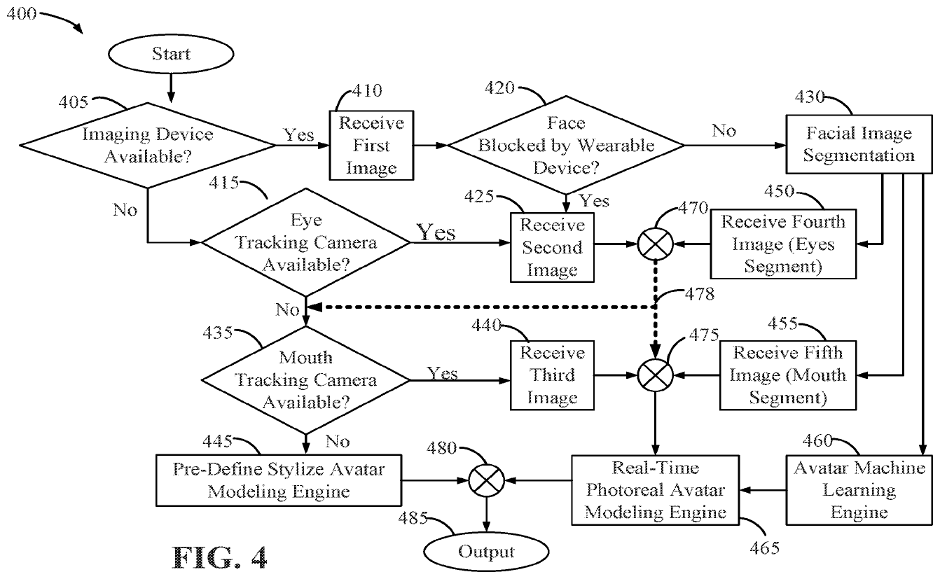

FIG. 4 is a flowchart illustrating an example avatar generation process 400 performed by the electronic processor 230 according to some examples. As illustrated in FIG. 4, the electronic processor 230 can determine whether an imaging device (e.g., the imaging device 255 of the computing device 210) is available to capture visual data (at block 405). For instance, the imaging device 255 can be available when the imaging device 255 is properly connected (such as to power and the computing device 210), configured, and enabled to capture visual data associated with the physical surroundings and environment of, e.g., the computing device 210. When the imaging device 255 is available (Yes at block 405), the process 400 can proceed to block 410, as described in greater detail below. When the imaging device 255 is not available (No at block 405), the process 400 can proceed to block 415, as described in greater detail below.

At block 410, the electronic processor 230 can receive a first image from the imaging device 255 (e.g., the second image data stream described herein with respect to block 310 of FIG. 3). The first image can include visual data associated with the physical surroundings and environment of, e.g., the computing device 210.

At block 420, the electronic processor 230 can determine whether a user's face is blocked (or obstructed) by a wearable device (e.g., the wearable device 205). The electronic processor 230 can determine whether the user's face is blocked by the wearable device 205 based on the first image from the imaging device 255 (e.g., the first image received at block 410). As one example, the electronic processor 230 can analyze the first image received at block 410 to determine whether a wearable device 205 is included in the first image and whether the wearable device 205 is being worn by the user (e.g., positioned such that at least a portion of the user's face is blocked).

When the wearable device 205 is blocking the user's face (Yes at block 420), the process 400 can proceed to block 425, as described in greater detail below. When the wearable device 205 is not blocking the user's face (No at block 420), the process 400 can proceed to block 430, as described in greater detail below.

At block 415, the electronic processor 230 can determine whether an eye tracking camera (e.g., a first wearable imaging device 255 of the wearable device 205, another eye tracking camera, etc.) is available. For instance, the eye tracking camera of the wearable device 205 can be available when the eye tracking camera (or the wearable device 205) is properly connected, configured, and enabled to capture visual data (e.g., eye tracking data) associated with the user wearing the wearable device 205. Accordingly, the eye tracking camera can capture visual image data associated with the eye(s) of a user wearing the wearable device 205. Eye tracking data can include eye-related data associated with performing eye tracking (e.g., application of an eye tracking algorithm). For example, eye tracking data (or eye-related data) can include eye motion data, pupil dilation data, gaze direction data, blink rate data, etc. In some examples, the eye-related data collected by the eye tracking camera can include data utilized by an eye tracking algorithm.

When the eye tracking camera of the wearable device 205 is available (Yes at block 415), the process 400 can proceed to block 425, as described in greater detail below. When the eye tracking camera of the wearable device 205 is not available (No at block 415), the process 400 can proceed to block 435, as described in greater detail below.

At block 425, the electronic processor 230 can receive a second image (or image data stream) from the eye tracking camera of the wearable device 205. The second image can include eye tracking data associated with a user wearing the wearable device 205. For instance, in some examples, the second image can include visual data associated with an eye segment or portion of the user wearing the wearable device 205.

At block 435, the electronic processor 230 can determine whether a mouth tracking camera (e.g., a second wearable imaging device 255 of the wearable device 205, another mouth tracking camera, etc.) is available. For instance, the mouth tracking camera of the wearable device 205 can be available when the mouth tracking camera (or the wearable device 205) is properly connected, configured, and enabled to capture visual data (e.g., mouth tracking data) associated with the user wearing the wearable device 205. Accordingly, the mouth tracking camera can capture visual image data associated with the mouth of a user wearing the wearable device 205. Mouth tracking data can include mouth-related data associated with performing mouth tracking (e.g., application of a mouth tracking algorithm). For example, mouth tracking data (or mouth-related data) can include mouth position data, lip position data, tongue position data, etc. In some examples, the mouth-related data collected by the mouth tracking camera can include data utilized by a mouth tracking algorithm.

When the mouth tracking camera of the wearable device 205 is available (Yes at block 435), the process 400 can proceed to block 440, as described in greater detail below. When the mouth tracking camera of the wearable device 205 is not available (No at block 435), the process 400 can proceed to block 445, as described in greater detail below.

At block 440, the electronic processor 230 can receive a third image (or image data stream) from the mouth tracking camera of the wearable device 205. The third image can include mouth tracking data associated with a user wearing the wearable device 205. For instance, in some examples, the second image can include visual data associated with a mouth segment or portion of the user wearing the wearable deice 205.

At block 445, the electronic processor 230 can execute a pre-defined stylized avatar modeling engine. In some examples, the electronic processor 230 executes the predefined stylized avatar modeling engine when no visual image data is available (e.g., no imaging devices are available). For example, when the imaging device 255 of the computing device 210 and the wearable imaging device(s) 225 (e.g., the eye tracking camera, the mouth tracking camera, etc.) of the wearable device 205 are unavailable (not collecting visual image data), the electronic processor 230 can execute the pre-defined stylized avatar modeling engine to generate (or select) a pre-defined stylized avatar. A pre-defined stylized avatar can refer to a pre-determined or default avatar, such as a pre-selected symbol or cartoon figure to be used to represent a user.

At block 430, the electronic processor 230 can perform a facial image segmentation to determine segmented datasets associated with facial segments. The electronic processor 230 can perform the facial image segmentation on the first image received at block 410 from the imaging device 255 of the computing device 210. The electronic processor 230 can perform the facial image segmentation by segmenting the first image into a set of facial segments. A facial segment can represent regions or portions of a user's face.

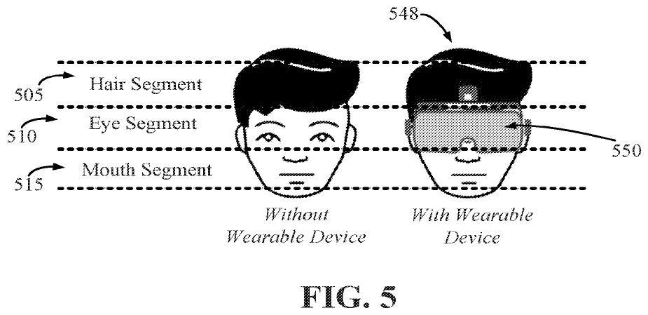

For example, FIG. 5 illustrates an example set of facial segments according to some examples. As illustrated in FIG. 5, the set of facial segments can include a hair segment 505, an eyes segment 510, and a mouth segment 515. The hair segment 505 can include a top portion of the user's face, which can include, e.g., the user's hair. The eyes segment 510 can include a middle portion of the user's face, which can include, e.g., the user's eyes, eyebrows, ears, etc. The mouth segment 515 can include a bottom portion of the user's face, which can include, e.g., the user's mouth, nose, etc. In some examples, the electronic processor 230 can determine additional, fewer, or different facial segments in different configurations than illustrated in FIG. 5.

In some examples, the electronic processor 230 can generate one or more segmented datasets, from the first image, where each segmented dataset is associated with a specific facial segment. In some examples, each segmented dataset is associated with a different facial segment. For example, a first segmented dataset can include visual data associated with a first facial segment (e.g., the hair segment 505 of FIG. 5), a second segmented dataset can include visual data associated with a second facial segment (e.g., the eyes segment 510 of FIG. 5), and a third segmented dataset can include visual data associated with a third facial segment (e.g., the mouth segment 515 of FIG. 5).

As illustrated in FIG. 4, after performing the facial image segmentation on the first image (at block 430), the electronic processor 230 can generate (or receive) a fourth image (at block 450) and a fifth image (at block 455). In the illustrated example, the fourth image can include the eyes segment (e.g., visual data associated with the eyes segment 510 of a user wearing the wearable device 205) and the fifth image can include the mouth segment (e.g., visual data associated with the mouth segment 515 of a user wearing the wearable device 205).

In some examples, the electronic processor 230 can provide the set of segmented datasets to an avatar machine learning engine (at block 460). In some examples, the first image received at block 410 (e.g., the set of segmented datasets) may be used as training data for training the avatar machine learning engine. Accordingly, when the user's face is subsequently blocked by the wearable device (Yes at block 420), the avatar machine learning engine may have access to a specific machine learning model for that particular user. The avatar machine learning engine (when executed by the electronic processor 230) can perform, e.g., interactive avatar development and deployment related functionality using one or more pre-trained interactive animation algorithms (e.g., a pre-trained deep neural network). An output of the avatar machine learning engine can be provided to a real-time photoreal avatar modeling engine (at block 465). An output of the avatar machine learning engine can include, e.g., a 3D model, audio, animation, text, etc. Accordingly, in some examples, the electronic processor 230 can apply the real-time photoreal avatar modeling engine to the output of the avatar machine learning engine, as described in greater detail herein.

In some examples, the electronic processor 230 can determine which visual data to use when generating the avatar. For example, as illustrated in FIG. 4, the electronic processor 230 can analyze the second image (received at block 425) and the fourth image (received at block 450) to determine whether to use the visual data associated with the second image, the fourth image, or a combination thereof to generate an eyes segment for the avatar (represented in FIG. 4 by reference numeral 470). Similarly, the electronic processor 230 can analyze the third image (received at block 440) and the fifth image (received at block 455) to determine whether to use the visual data associated with the third image, the fifth image, or a combination thereof to generate a mouth segment for the avatar (represented in FIG. 4 by reference numeral 475).

As one example, with reference to FIG. 5, when a user is wearing the wearable device 205 (represented in FIG. 5 by reference numeral 548), the electronic processor 230 can determine that the eyes segment included in the first image (as captured by the imaging device 255 of the computing device 210) is obstructed by the wearable device 205 (represented in FIG. 5 by reference numeral 550). Following this example, when the electronic processor 230 also received visual image data associated with the eye segment (e.g., the fourth image received at block 450), the electronic processor 230 can determine to use the visual image data associated with the fourth image as opposed to the visual image data associated with the first image where the eye segment is obstructed by the wearable device 205.

After determining which visual data to use for each facial segment (e.g., the eyes segment 510 and the mouth segment 515), the electronic processor 230 can provide that visual data to the real-time photoreal avatar modeling engine (at block 465). For instance, the electronic processor 230 can apply the real-time photoreal avatar modeling engine to the visual data. The real-time photoreal avatar modeling engine (when executed by the electronic processor 230) can perform real-time 3D creation functionality, such as, e.g., for photoreal visuals and immersive experiences, as part of a 3D development process.

In some examples, the electronic processor 230 may provide various combinations of visual data (e.g., the first image, the second image, the third image, etc. of FIG. 4) to the real-time photoreal avatar modeling engine based on, e.g., the availability of sensors, such as the wearable imaging device(s) 225, the imaging device(s) 255, etc. (as represented in FIG. 4 by the dotted line(s) associated with reference numeral 478). As one example, even when the eye tracking camera is available (Yes at block 415), the electronic processor 230 can still determine whether the mouth tracking camera is available (at block 435).

In some examples, the electronic processor 230 can analyze the outputs from the pre-defined stylize avatar modeling engine, the real-time photoreal avatar modeling engine, or a combination thereof (represented in FIG. 4 by reference numeral 480) in order to generate the avatar and output the avatar (at block 485).

Accordingly, in some examples, the electronic processor 230 can dynamically analyze tracking cameras from multiple origins (e.g., the eye tracking camera, the mouth tracking camera, etc.). Based on this dynamic analysis, the electronic processor 230 can determine an optimal camera array configuration, minimize power consumption, and select most suitable tracking algorithm, which ultimately can result in generating an improved digital avatar (e.g., with increased quality or accuracy in representation of a user).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of.”

Although the present technology has been described by referring to preferred examples, workers skilled in the art will recognize that changes can be made in form and detail without departing from the scope of the discussion.

What is claimed is:

1. A system, comprising:
a first camera to detect a first image data stream including a facial feature of a participant, the first camera included in a wearable device worn by the participant;
a second camera to detect a second image data stream including a non-facial feature of the participant, the second camera separate from the wearable device and associated with a computing device; and
an electronic processor to:
receive, from the first camera, the first image data stream;
receiving, via the second camera, the second image data stream; and
generate an avatar of the participant, wherein a first portion of the avatar including the facial feature is generated based on the first image data stream and a second portion of the avatar including the non-facial feature is generated based on the second image data stream.

2. The system of claim 1, wherein the second camera is internal to the computing device of the participant.

3. The system of claim 1, wherein the facial feature includes at least one of an eye of the participant and a mouth of a participant.

4. The system of claim 1, wherein, as part of the facial image segmentation, the electronic processor
generates a first set of segmented datasets from the first image data stream;
generates a second set of segmented datasets from the second image data stream; and
identifies a first segmented dataset from the first set of segmented datasets and a second segmented dataset from the second segmented datasets, wherein the first segmented dataset and the second segmented dataset each include visual data associated with a facial segment,
wherein the avatar is generated based on the first segmented dataset or the second segmented dataset.

5. The system of claim 4, wherein the avatar is generated based on the first segmented dataset when the second segmented dataset includes an obstructed feature.

6. The system of claim 4, wherein the facial segment includes at least one of an eyes segment or a mouth segment.

7. The system of claim 4, wherein the electronic processor
identifies, from a plurality of tracking algorithms, a tracking algorithm specific to the facial segment; and
applies the tracking algorithm to the first segmented dataset and the second segmented dataset.

8. The system of claim 7, wherein the tracking algorithm includes at least one of eye gaze tracking algorithm, head pose tracking algorithm, lip movement tracking algorithm, body part tracking algorithm, hand tracking algorithm, and finger tracking algorithm.

9. A method, comprising:
receiving, via a first camera of a wearable device, a first image data stream that includes a facial feature of a participant;
receiving, via a second camera separate from the wearable device, a second image data stream that includes a non-facial feature of the participant; and
generating an avatar of the participant, wherein a first portion of the avatar including the facial feature is generated based on the first image data stream and a second portion of the avatar including the non-facial feature is generated based on the second image data stream.

10. The method of claim 9, further comprising:
displaying the avatar of the participant via a computing device of the participant.

11. The method of claim 9, further comprising:
transmitting the avatar to a remote computing device for display to at least one additional participant.

12. The method of claim 9, further comprising:
generating a first set of segmented datasets from the first image data stream;
generating a second set of segmented datasets from the second image data stream; and
identifying a first segmented dataset from the first set of segmented datasets and a second segmented dataset from the second segmented datasets, wherein the first segmented dataset and the second segmented dataset each include visual data associated with a facial segment,
wherein the avatar is generated based on the first segmented dataset or the second segmented dataset.

13. A non-transitory computer-readable medium storing instructions that, when executed by an electronic processor cause the electronic processor to:
receive, via a first camera of a wearable device, a first image data stream that includes a facial feature of a participant, wherein the facial feature is the eyes of the participant;
receive, via a second camera separate from the wearable device, a second image data stream that includes a non-facial feature of the participant; and
generate an avatar of the participant, wherein a first portion of the avatar including the facial feature is generated based on the first image data stream and a second portion of the avatar including the non-facial feature is generated based on the second image data stream.

14. The computer-readable medium of claim 13, wherein the instructions, when executed by the electronic processor, cause the electronic processor to:
display the avatar of the participant via a computing device of the participant; and
transmit the avatar to a remote computing device for display to at least one additional participant.

15. The computer-readable medium of claim 13, wherein the instructions, when executed by the electronic processor, cause the electronic processor to:
generate a first set of segmented datasets from the first image data stream;
generate a second set of segmented datasets from the second image data stream; and
identify a first segmented dataset from the first set of segmented datasets and a second segmented dataset from the second segmented datasets, wherein the first segmented dataset and the second segmented dataset each include visual data associated with a facial segment,
wherein the avatar is generated based on the first segmented dataset or the second segmented dataset.
